(19) United States
(12) Patent Application Publication
(10) Pub. No.: US 2025/0259294 A1
(43) Pub. Date: Aug. 14, 2025

(54) SYSTEM AND METHOD FOR GENERATING NON-DESTRUCTIVE TESTING SCENE-BASED USER INTERFACE ELEMENTS

(71) Applicant: Baker Hughes Holdings LLC, Houston, TX (US)

(72) Inventors: Kevin Coombs, Syracuse, NY (US); Sheldon McCrackin, Houston, TX (US)

(21) Appl. No.: 19/042,581

(22) Filed: Jan. 31, 2025

Related U.S. Application Data
(60) Provisional application No. 63/553,309, filed on Feb. 14, 2024.

(51) Int. Cl. G06T 7/00; G06F 3/04845; G06F 3/0486

(52) U.S. Cl. CPC G06T 7/0008; G06F 3/04845; G06F 3/0486; G06T 2207/30108

(57) ABSTRACT

Inspection systems and methods of inspection are provided that include an image sensor to acquire inspection data characterizing a video of at least a portion of an asset being inspected, wherein the asset includes one or more components, and a computing system communicatively coupled to the image sensor. The computing system includes a user interface display, a processor and a memory storing instructions which, when executed by the processor causes the processor to perform operations including: receiving, from the image sensor, the inspection data, identifying, automatically, at least a first component of the one or more components, generating a graphical user interface (GUI) including the inspection data, generating a first dynamic identifier within the GUI, wherein the first dynamic identifier corresponds to the first component and is arranged to follow the first component as it moves within the GUI, and providing the GUI to the user interface display.

### CROSS-REFERENCE TO RELATED APPLICATIONS

This application claims priority under to U.S. Provisional Application No. 63/553,309, filed Feb. 14, 2024, and entitled “SYSTEM AND METHOD FOR GENERATING NON-DESTRUCTIVE TESTING SCENE-BASED USER INTERFACE ELEMENTS,” the contents of which are hereby incorporated by reference in their entirety.

### BACKGROUND

The subject matter disclosed herein relates generally to a system and method for generating scene-based identifiers within a user interface of a non-destructive testing (NTD) device (e.g., a display of a video borescope device).

Video inspection devices, such as video endoscopes or borescopes, can be used to inspect objects/assets to identify and analyze anomalies that may have resulted from, e.g., damage, wear, corrosion, improper installation, etc. In many instances, these inspections can include performing repetitive inspections of objects/assets that have a plurality of similar elements (e.g., a turbine having a plurality of similar blades).

### SUMMARY

In one aspect, a method of generating scene-based identifiers within a user interface of a non-destructive testing (NTD) device is provided. The method includes acquiring, by an image sensor of an inspection system, inspection data characterizing a video of at least a portion of an asset being inspected, where the asset includes one or more components. The method also includes receiving, from the image sensor by one or more processors of the inspection system, the inspection data, identifying, automatically by the one or more processors, at least a first component of the one or more components, generating, by the one or more processors, a graphical user interface (GUI) including the inspection data, and generating, by the one or more processors, a first dynamic identifier within the GUI, where the first dynamic identifier corresponds to the first component and is arranged to follow the first component as it moves within the GUI. The method also includes providing the GUI to a user interface display of the inspection system.

In some aspects, the first dynamic identifier can be displayed be over top of and move dynamically with the first component. In some aspects, the first dynamic identifier can include a visual indication of at least one of a first component type, a first component number, or a boundary of the first component.

In some aspects, the method can include determining, automatically by the one or more processors, an inspection status of the first component or a defect within the first component and modifying, by the one or more processors, a visual appearance of the first dynamic identifier to notify a user of the inspection status of the first component or a defect within the first component.

In some aspects, the method can include generating, by the one or more processors, within the GUI, a component information window including at least one of measurement data, analytic analysis results, an inspection status, geometric data, a flag for further review, an image quality metric, or inspection history data.

In some aspects, the method can include receiving, from a user via the GUI, an interaction with the first dynamic identifier and adjusting a position of the first dynamic identifier within the GUI based on the interaction. In some aspects, the interaction can include a click and drag interaction by the user to move the first dynamic identifier from a first position within the GUI to a second position within the GUI.

In some aspects, the inspection system may be a borescope and the asset being inspected can be a turbine and the one or more components can include one or more turbine blades. In some aspects, the method can include rotating the turbine using a turning tool while acquiring the inspection data such that the inspection data includes a video of at least a portion of the plurality of turbine blades. In some aspects, the identifying includes identifying at least a first turbine blade of the plurality of turbine blades. In some aspects, the first dynamic identifier corresponds to a first turbine blade of the plurality and can be arranged to follow the first turbine blade within the GUI as the turbine is rotated.

In another aspect, an inspection system is provided that includes an image sensor arranged to acquire inspection data characterizing a video of at least a portion of an asset being inspected, where the asset includes one or more components. The inspection system also includes a computing system communicatively coupled to the image sensor and including a user interface display, one or more processors and a memory storing instructions which, when executed by the one or more processors cause the one or more processors to perform operations. The operations performed by the one or more processors include receiving, from the image sensor, the inspection data, identifying, automatically, at least a first component of the one or more components, generating a graphical user interface (GUI) including the inspection data, and generating a first dynamic identifier within the GUI, where the first dynamic identifier corresponds to the first component and may be arranged to follow the first component as it moves within the GUI. The operations performed by the one or more processors also include providing the GUI to the user interface display.

In some aspects, the first dynamic identifier can be displayed be over top of and move dynamically with the first component. In some aspects, the first dynamic identifier can include a visual indication of at least one of a first component type, a first component number, or a boundary of the first component.

In some aspects, the one or more processors may be arranged to perform operations further including determining, automatically, an inspection status of the first component or a defect within the first component and modifying a visual appearance of the first dynamic identifier to notify a user of the inspection status of the first component or a defect within the first component.

In some aspects, the one or more processors may be arranged to perform operations further including generating, within the GUI, a component information window including at least one of measurement data, analytic analysis results, an inspection status, geometric data, a flag for further review, an image quality metric, or inspection history data.

In some aspects, the one or more processors may be arranged to perform operations further including receiving, from a user via the GUI, an interaction with the first dynamic identifier and adjusting a position of the first dynamic identifier within the GUI based on the interaction. In some aspects, the interaction can include a click and drag interaction by the user to move the first dynamic identifier from a first position within the GUI to a second position within the GUI.

In another aspect, a borescope system is provided that includes an image sensor arranged to acquire inspection data characterizing a video of at least a portion of a turbine being inspected, where the turbine includes a plurality of turbine blades. The borescope system also includes a computing system communicatively coupled to the image sensor and including a user interface display, one or more processors and a memory storing instructions which, when executed by the one or more processors cause the one or more processors to perform operations. The operations performed by the one or more processors include receiving, from the image sensor, the inspection data, identifying, automatically, at least a first turbine blade of the plurality of turbine blades, generating a graphical user interface (GUI) including the inspection data, and generating a first dynamic identifier within the GUI, where the first dynamic identifier corresponds to the first turbine blade of the plurality and may be arranged to follow the first turbine blade as it moves within the GUI. The operations performed by the one or more processors also include providing the GUI to the user interface display.

In some aspects, the borescope system can include a turning tool arranged to rotate the turbine while the image sensor is acquiring the inspection data.

In some aspects, the GUI can include a turning tool interface arranged to allow for a user to control the rotation of the turbine and the one or more processors may be arranged to perform operations further including receiving, from the user via the GUI, an interaction with the turning tool interface and controlling the turning tool to rotate the turbine based on the interaction.

In some aspects, the first dynamic identifier includes a visual indication of at least one of a first turbine blade number, or a boundary around the first turbine.

### BRIEF DESCRIPTION OF THE DRAWINGS

These and other features will be more readily understood from the following detailed description taken in conjunction with the accompanying drawings, in which:

FIG. 1 is a flow diagram of an exemplary method for generating scene-based identifiers within a user interface of an NTD device;

FIG. 2 illustrates an exemplary embodiment of a GUI of a video inspection device displaying dynamic scene-based identifiers of at least a portion of an asset being inspected;

FIGS. 3A-3C illustrate an exemplary embodiment of a GUI of a video inspection device displaying a dynamic scene-based identifier over top of a portion of an asset being inspected;

FIG. 4 is a block diagram of an exemplary video inspection device according to the systems and methods described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Traditionally, video inspection devices, such as video endoscopes or borescopes, can be used to inspect objects/assets to identify and analyze anomalies that may have resulted from, e.g., damage, wear, corrosion, improper installation, etc. In many instances, these inspections can include performing repetitive inspections of objects/assets that have a plurality of similar components. For example, inspections can evaluate a turbine having a plurality of similar blades, a gear having a plurality of teeth, a set of similar bearings, etc. Conventionally, systems can be configured to display an identifier for the most prominent component in a scene, in a static position on graphical user interface (GUI) for a user to view (e.g., a static identifier displayed in a corner of the GUI). However, under this conventional approach, the user may be confused as to which component of the plurality of similar components is being represented by the identifier. Further, traditionally, information corresponding to an inspection of each component of a plurality of similar components being inspected are not displayed within the GUI in an intuitive, concise manner.

Accordingly, the systems and methods described herein address the aforementioned shortcomings by providing a video inspection system including an image sensor, a display, and a processor configured to generate dynamic scene-based identifiers of at least a portion of an asset being inspected, collate known information about the portion of an asset, and displaying the information dynamically, over top of the corresponding portion of the asset as the portion comes into view within the display. For example, in some aspects, the at least one processor is configured to receive, from the image sensor, data characterizing a video of at least a portion of a first component of one or more components of an asset, generate a graphical user interface (GUI) comprising the video and generate, within the GUI, a first dynamic identifier corresponding to the first component, wherein the first dynamic identifier is configured to displayed be over top of and move dynamically with the first component.

Advantageously, the systems and methods described herein intuitively provide an inspector with information about a portion of an asset being inspected, without the inspector having to exhaustively search through inspection files and menus or decipher which inspection information corresponds to which portion of the asset being inspected.

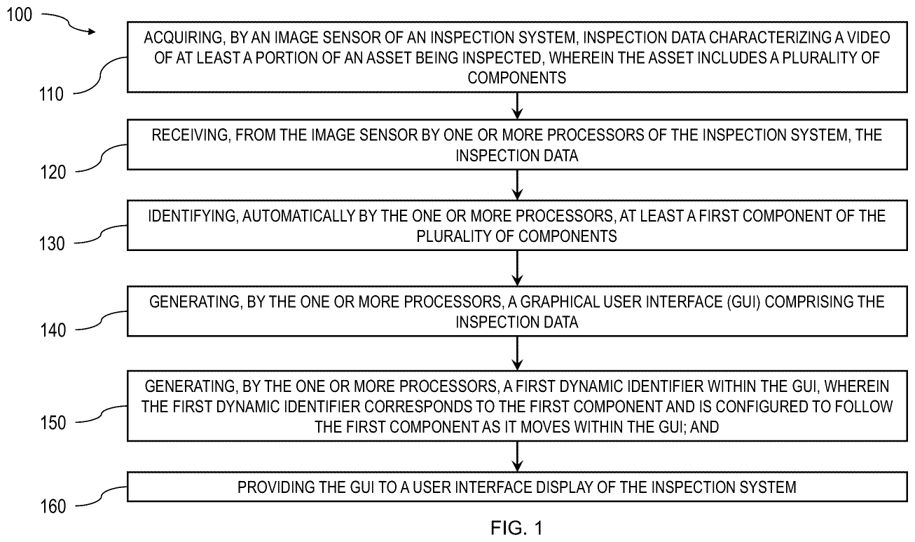

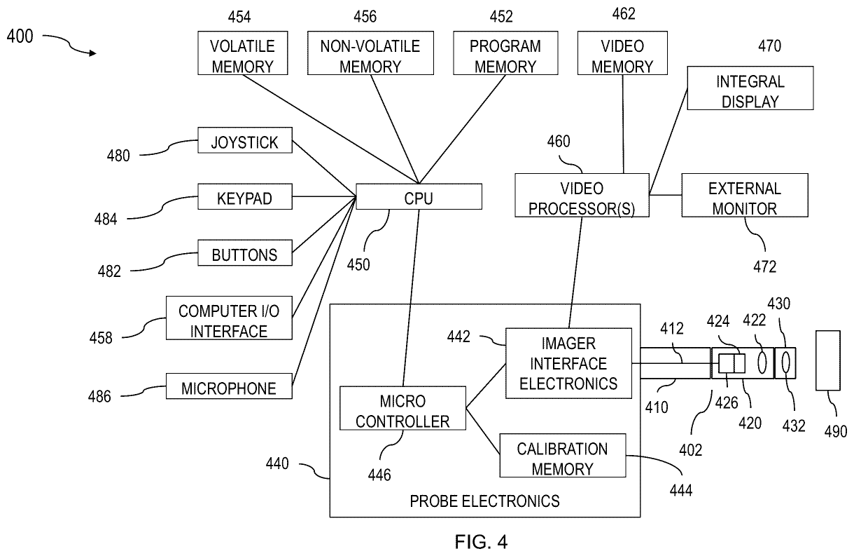

FIG. 1 is a flow diagram of an exemplary method 100 for generating non-destructive testing scene-based user interface components within a GUI of a video inspection device. In some aspects, the method 100 can be executed on a borescope device (also described herein as a video inspection device) which can include, but is not limited to, an image sensor, a display, a memory storing instructions and one or more processors configured to perform operations. An exemplary borescope device according to the subject matter described herein is provided in greater detail below in reference to FIG. 4.

As shown in FIG. 1, the method 100 includes a step 110 of acquiring, by an image sensor of an inspection system, inspection data characterizing a video of at least a portion of an asset being inspected, wherein the asset includes one or more components. For example, in some aspects the image sensor can be a camera of a borescope. In some aspects, the asset can a turbine and the one or more components include one or more turbine blades. In some aspects, the asset can also be any industrial asset.

The method 100 also includes a step 120 of receiving from the image sensor by one or more processors of the inspection system, the inspection data. For example, in some aspects, the asset being inspected can be a turbine having a plurality of blades and the video can be configured to display each blade of the plurality of blades as they rotate past an image sensor of the system. In some aspects, the rotation of the turbine can be facilitated by a turning tool or the like during an inspection. While a turbine is used in the illustrative example, it should be known that the systems and methods described herein can be configured to capture video of a variety of assets comprising one or more components, including but not limited to, gears, bearings, windmills, compressors, as well as any other industrial assets. In some aspects, the data characterizing the video can be comprised of structured light images, white light images, stereoscopic images, or the like.

The method 100 also includes a step 130 identifying, automatically by the one or more processors, at least a first component of the one or more components. In some aspects, one or more processors can be arranged to identify the first component of the one or more components using one or more Automatic Defect Recognition (ADR) tools, image recognition algorithms, machine learning models or the like. In some aspects, the identifying can further include identifying/determining, automatically by the one or more processors, an inspection status of the first component or a defect within the first component.

The method 100 also includes a step 140 of generating, by the one or more processors, a graphical user interface (GUI) including the inspection data. For example, in some aspects, the GUI can be displayed within the display of the borescope device. In this way, a user can navigate the image sensor of the borescope within the asset while viewing a live video feed on the display as seen from the image sensor. When the user reaches a portion of the asset that they wish to inspect, they can interact with the borescope to being capturing the video to use for the inspection. Additionally, for example, the asset can be a component having a plurality of similar components (e.g., a turbine having a plurality of similar blades) which can be inspected by rotating the turbine through a plurality of positions while capturing images/videos of the asset from the stationary image sensor, as described in greater detail below.

The method 100 also includes a step 150 of generating, by the one or more processors, a first dynamic identifier within the GUI, wherein the first dynamic identifier corresponds to the first component and is arranged to follow the first component as it moves within the GUI. In some aspects, the first dynamic identifier can include a visual indication of at least one of a first component type, a first component number, or a boundary of the first component, as discussed in greater detail below. In some aspects, the first dynamic identifier can be displayed be over top of and move dynamically with the first component as the first component comes into view in the video. With reference to the example provided above, the first component can be a first blade of a turbine having a plurality of blades and the first dynamic identifier can be configured to identify the first blade. For example, the first component type can include data characterizing a component type of the first component (e.g., “Blade” or “Gear Tooth”, etc.) and the first component number can include data characterizing a number identifier corresponding to the first component (e.g., 1, 2, 3, . . . . N). In this example, the fifth blade in the turbine would have a first dynamic identifier of “Blade 5”. The first component type and the first component number can also include other identifying data including, but not limited to, a manufacturer, a model number, a serial number, an asset to which the first component is a component of, a machine to which the asset is a component of, etc. In some aspects, the boundary of the first component can include a visual indication of the confines of the first component. For example, the component boundary can include a bounding box, a shading and/or or segmented overlay providing a visual indication of the perimeter of the blade.

In some aspects, if the one or more processors is arranged to determine an inspection status of the first component or a defect within the first component, the one or more processors can modify a visual appearance of the first dynamic identifier to notify a user of the inspection status of the first component or a defect within the first component, as described in greater detail below. In some aspects the one or more processors can also be arranged to generate a component information window, either as a part of the first dynamic identifier, or as a separate GUI element. In some aspects, component information window can include at least one of measurement data, analytic analysis results, an inspection status, geometric data, a flag for further review, an image quality metric, or inspection history data.

The method also includes a step 160 of providing the GUI to a user interface display of the inspection system to be viewed and interacted with by a user. In some aspects, the method can also include steps of receiving, from a user via the GUI, an interaction with the first dynamic identifier, and adjusting a position of the first dynamic identifier within the GUI based on the interaction. For example, in some aspects, the interaction can include a click and drag, by the user configured to move the first dynamic identifier from a first position within the GUI to a second position within the GUI. In some aspects, the user interface display can be a touchscreen and the click and drag can be provided to user interface display using a finger of the user or a stylus or the like. In some aspects, the click and drag can be provided via a joystick, or a cursor movement, or a slider adjustment, or a push button or the like.

In some aspects, if the asset is a rotatable asset (e.g. a turbine, gear, bearing, windmill, compressor, etc.), the asset can be coupled to a turning too and the GUI can further include a turning tool interface that is arranged to allow for the user to control a rotation of the asset via the turning tool. In this case, the method can further include a step of receiving, from the user via the GUI, an interaction with the turning tool interface, and controlling the turning tool to rotate the asset based on the interaction. In some aspects, the first dynamic identifier can be arranged to follow the first component within the GUI as the asset is rotated by the turning tool.

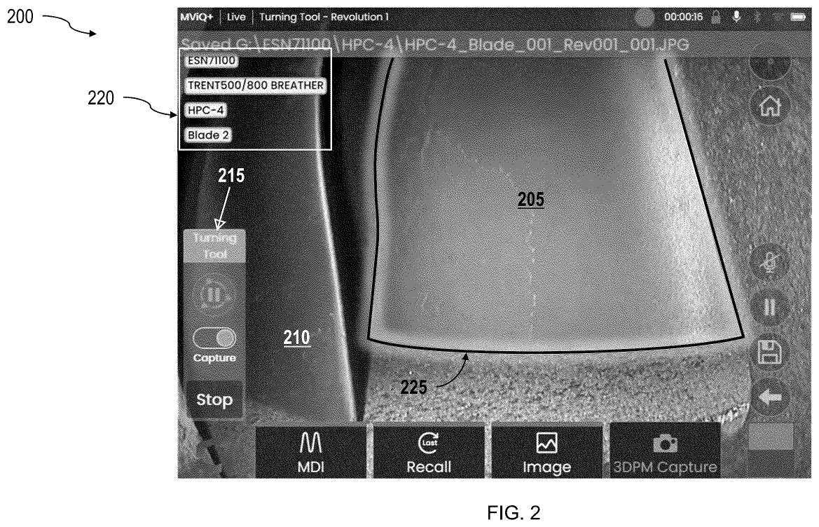

FIG. 2 illustrates an exemplary embodiment of a GUI 200 of a video inspection device displaying dynamic scene-based identifiers of at least a portion of an asset being inspected. In some aspects, similarly to as described above, the video inspection device can include an image sensor, a memory storing instructions, one or more processors configured to perform operations and a display including the GUI 200. During an inspection, the video inspection device can be configured to acquire a plurality of images and/or a video of at least a portion of an asset comprising one or more components, and the processor can provide the images and video to the GUI 200 to be viewed by the user. For example, as shown in FIG. 2, the asset being inspected can be a turbine having a plurality of blades 205, 210 and the video can be configured to display each blade 205, 210 of the plurality of blades as they rotate past an image sensor of the system. In some aspects, the rotation of the turbine can be facilitated by a turning tool or the like during an inspection which can be controlled via the GUI 200 by interacting with a turning tool interface 215. When the user reaches a portion of the asset that they wish to inspect, they can interact with the GUI 200 to being capturing the images/video to be stored within the memory of the system for use in the inspection.

As the asset is rotated during the inspection (e.g., by the turning tool) the processor can be configured to automatically identify each blade 205, 210 as they come into view of the image sensor. Responsive to identifying each blade 205, 210, the processor can be configured to generate one or more dynamic scene-based identifiers configured to provide visual identifying information within the GUI 200 corresponding to each blade 205, 210. For example, responsive to identifying blade 205, the processor can be configured to generate one or more dynamic scene-based identifiers 220, 225 corresponding to the first blade 205. In some aspects, as shown in FIG. 2, the dynamic scene-based identifiers 220, 225 include at least one of a first component type and a first component number, a manufacturer, a model number, a serial number, an asset to which the first component is a component of, a machine to which the asset is a component of, an component boundary, etc. For example, the dynamic scene-based identifier 220 can include data characterizing a component type of the first component (e.g., “Blade 2”). The dynamic scene-based identifier 225 can be an component boundary providing a visual indication of the confines of the blade 205. For example, the dynamic scene-based identifier 225 a bounding box, a shading and/or or segmented overlay providing a visual indication of the perimeter of the blade 205. In some aspects, other information about each blade 205, 210 can also be presented (e.g., in the form of additional text, different color indicators, or other graphical elements). The dynamic scene-based identifiers 220, 225 can further include measurement data relating to each blade 205, 210, analytic analysis results for each blade, status of inspection requirements completion for each blade (e.g., menu directed inspection (MDI) completion status), actual geometric measurement results, presence of a flag for further review by either a human or an analytic, an image quality metric, data related to a prior inspection of the each blade, etc. As the turbine continues to rotate, the processor can be configured to automatically generate a new set of dynamic scene-based identifiers corresponding to a next blade as the next blade comes into view.

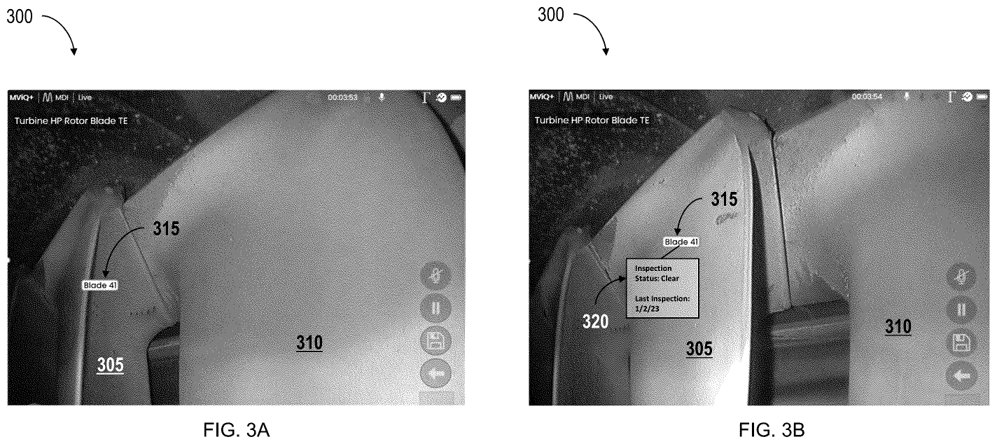

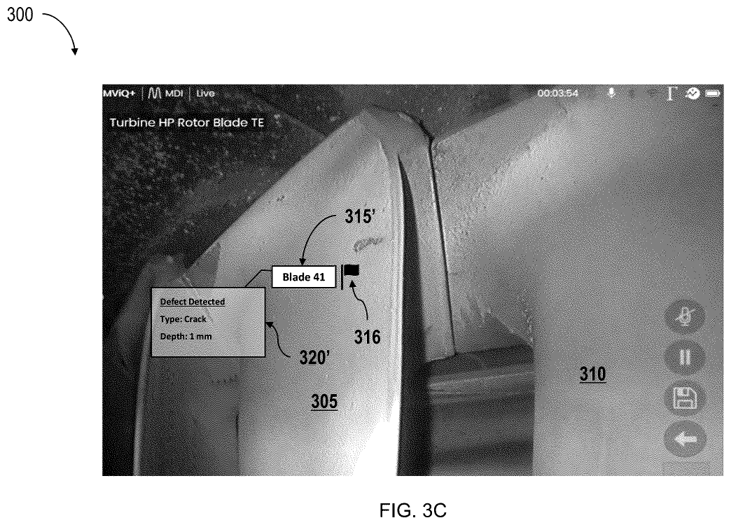

FIGS. 3A-3B illustrate an exemplary embodiment of a GUI 300 of a video inspection device displaying another dynamic scene-based identifier over top of a portion of an asset being inspected as the portion of the asset moves within the GUI 300 as a result of the image sensor moving or the portion of the asset moving, or a combination thereof. For example, as shown in FIGS. 3A-3B, the asset being inspected can be a turbine having a plurality of blades 305, 310 and the video can be configured to display each blade 305, 310 of the plurality of blades as they rotate past an image sensor of the system. As the asset is rotated during the inspection (e.g., by the turning tool) the processor can be configured to automatically identify each blade 305, 310 as they come into view of the image sensor and generate one or more dynamic scene-based identifiers configured to provide visual identifying information within the GUI 300 corresponding to each blade 305, 310, similarly to as described above. For example, responsive to identifying blade 305, the processor can be configured to generate a dynamic scene-based identifier 315 corresponding to the blade 305. In some aspects, the dynamic scene-based identifier 315 can be similar to the dynamic scene-based identifiers described above in reference to FIG. 2. In some aspects, the dynamic scene-based identifier 315 can be displayed be over top of and move dynamically with the blade 305 as the blade 305 moves from a first position, shown in FIG. 3A, to a second position, shown in FIG. 3B. In some aspects, as the turbine continues to rotate, the processor can be configured to automatically generate a new set of dynamic scene-based identifiers corresponding to a next blade as the next blade comes into view. In some aspects, the user may be navigating the image sensor of the borescope within the asset while the blade 305 or other component being inspected (e.g. a fuel nozzle) stationary. In this case, the blade 305 or other component being inspected would still be moving within the user interface display. Accordingly, the processor can still be arranged to display the identifier 315 over top of the blade 305 and move it dynamically with the blade 305 as the image sensor is moved from a first position, shown in FIG. 3A, to a second position, shown in FIG. 3B. A combination of movement of the asset being inspected and movement of the image sensor is also realized. In some aspects, the image sensor of the borescope can be navigated manually by a user or by using a motorized probe driver controlled by a joystick or the like, as discussed in greater detail below.

In some aspects, the one or more processors can also be arranged to generate a component information window 320, as shown in FIG. 3B, either as a part of the first dynamic identifier 315, or as a separate GUI element. In some aspects, the component information window 320 can be generated automatically, with no user input. However, in some aspects, the user (e.g., an inspector) can interact with the dynamic scene-based identifier 315 within the GUI 300 to access the component information window 320 for the blade 305. For example, in some aspects, responsive to the user selecting the dynamic scene-based identifier 315, the processor of the system can be configured to generate the component information window 320 within the GUI. In some aspects, the component information window 320 can include one or more of measurement data, analytic analysis results, an inspection status, geometric data, a flag for further review, an image quality metric and inspection history data. In some aspects, the component information window 320 can be linked to the dynamic scene-based identifier 315 via a visual line or other non-text element and can be presented remotely from the dynamic scene-based identifier 315 within the GUI 300, as shown. In some aspects, the component information window 320 can be similar to a drop-down menu that drops down from the dynamic scene-based identifier 315, either automatically or responsive to the user interacting with the dynamic scene-based identifier 315. The user may also be enabled to adjust a position of the dynamic scene-based identifier 315 and/or the component information window 320 relatively (e.g., 25% left of center), absolutely (e.g., center, left, on top of a detected leading edge of the first component, etc). In some aspects, the user can also arbitrarily click and drag the dynamic scene-based identifier 315 and/or the component information window 320, either by using a joystick of the video inspection device, or by interacting with a touchscreen display presenting the GUI 300.

In some aspects, as described above, the one or more processors of the systems described herein can be arranged to automatically identify/determine an inspection status of the first component or a defect within the first component using one or more Automatic Defect Recognition (ADR) tools, image recognition algorithms, machine learning models or the like. Accordingly, in some aspects, the one or more processors can modify a visual appearance of the first dynamic identifier 315 to notify a user of the inspection status of the first component 305 or a defect within the first component 305. For example, FIG. 3C illustrates the GUI 300 displaying a modified dynamic identifier 315′, which has been modified to visually notify a user of the inspection status of the first component 305 or a defect within the first component 305. For example, in some aspects, the modified dynamic identifier 315′ can be presented in a different color, size, or shape than the typical dynamic identifier 315. However, any other viable means of modifying the visual appearance of the first dynamic identifier 315 to notify a user of the inspection status or of a defect is also realized. For example, in some aspects, the modified dynamic identifier 315′ can include a flag 316 or the like, which can be generated next to the modified dynamic identifier 315′ and can act as a flag in the inspection for further review.

In this case, the one or more processors can also be arranged to generate a component information window 320′, as shown in FIG. 3C, either as a part of the modified first dynamic identifier 315′, or as a separate GUI element. In some aspects, the component information window 320′ can be generated automatically, or responsive to a user input, similarly to as described above. In some aspects, the component information window 320′ can include an indication of the defect, the defect type (e.g., cracks, wear, thermal damage, erosion, corrosion, the presence of a foreign object, etc.). The component information window 320′ can also include an image quality metric, inspection history data and/or geometric data (e.g., a dimension of the defect). In some aspects, the component information window 320′ and/or the flag 316 can be linked to the modified dynamic scene-based identifier 315′ via a visual line or other non-text element and can be presented remotely from the modified dynamic scene-based identifier 315′ within the GUI 300, similarly to as described above. The user may also be enabled to adjust a position of the modified dynamic scene-based identifier 315′, the component information window 320′ and/or the flag 316 similarly to as described above.

FIG. 4 is a block diagram of an exemplary video inspection device 400 according to the systems and methods described herein. It will be understood that the video inspection device 400 shown in FIG. 4. Is exemplary and that the scope of the invention is not limited to any particular video inspection device 400 or any particular configuration of components within a video inspection device 400.

Video inspection device 400 can include an elongated probe 402 comprising an insertion tube 410 and a head assembly 420 disposed at the distal end of the insertion tube 410. Insertion tube 410 can be a flexible, tubular section through which all interconnects between the head assembly 420 and probe electronics 440 are passed. Head assembly 420 can include probe optics 422 for guiding and focusing light from the viewed object 490 onto an imager 424. The probe optics 422 can comprise, e.g., a lens singlet or a lens having multiple components. The imager 424 can be a solid-state CCD or CMOS image sensor for obtaining an image of the viewed object 490.

A detachable tip or adaptor 430 can be placed on the distal end of the head assembly 420. The detachable tip 430 can include tip viewing optics 432 (e.g., lenses, windows, or apertures) that work in conjunction with the probe optics 422 to guide and focus light from the viewed object 490 onto an imager 424. The detachable tip 430 can also include illumination LEDs (not shown) if the source of light for the video inspection device 400 emanates from the tip 430 or a light passing element (not shown) for passing light from the probe 402 to the viewed object 490. The tip 430 can also provide the ability for side viewing by including a waveguide (e.g., a prism) to turn the camera view and light output to the side. The tip 430 may also provide stereoscopic optics or structured-light projecting elements for use in determining three-dimensional data of the viewed surface. The elements that can be included in the tip 430 can also be included in the probe 402 itself.

The imager 424 can include a plurality of pixels formed in a plurality of rows and columns and can generate image signals in the form of analog voltages representative of light incident on each pixel of the imager 424. The image signals can be propagated through imager hybrid 426, which provides electronics for signal buffering and conditioning, to an imager harness 412, which provides wire for control and video signals between the imager hybrid 426 and the imager interlace electronics 442. The imager interface electronics 442 can include power supplies, a timing generator for generating imager clock signals, an analog front end for digitizing the imager video output signal, and a digital signal processor for processing the digitized imager video data into a more useful video format.

The imager interface electronics 442 are part of the probe electronics 440, which provide a collection of functions for operating the video inspection device. The probe electronics 440 can also include a calibration memory 444, which stores the calibration data for the probe 402 and/or tip 430. A microcontroller 446 can also be included in the probe electronics 440 for communicating with the imager interface electronics 442 to determine and set gain and exposure settings, storing and reading calibration data from the calibration memory 444, controlling the light delivered to the viewed object 490, and communicating with a central processor unit (CPU) 450 of the video inspection device 400.

In addition to communicating with the microcontroller 446, the imager interface electronics 442 can also communicate with one or more video processors 460. The video processor 460 can receive a video signal from the imager interface electronics 442 and output signals to various monitors 470, 472, including an integral display 470 or an external monitor 472. The integral display 470 can be an LCD screen built into the video inspection device 400 for displaying various images or data (e.g., the image of the viewed object 490, menus, cursors, measurement results) to an inspector. The external monitor 472 can be a video monitor or computer-type monitor connected to the video inspection device 400 for displaying various images or data.

The video processor 460 can provide/receive commands, status information, streaming video, still video images, and graphical overlays to/from the CPU 450 and may be comprised of FPGAs, DSPs, or other processing elements which provide functions such as image capture, image enhancement, graphical overlay merging, distortion correction, frame averaging, scaling, digital zooming, over laying, merging, flipping, motion detection, and video format conversion and compression.

The CPU 450 can be used to manage the user interface by receiving input via a joystick 480, buttons 482, keypad 484, and/or microphone 486, in addition to providing a host of other functions, including image, video, and audio storage and recall functions, system control, and measurement processing. The joystick 480 can be manipulated by the user to perform such operations as menu selection, cursor movement, slider adjustment, and articulation control of the probe 402, and may include a push button function. In some aspects, for example, the joystick 480 can be manipulated by the user to control the movements of the borescope probe 402 via a probe driver (not shown). The probe driver is a device that motorizes push and/or twisting movements of the borescope probe 402. The buttons 482 and/or keypad 484 also can be used for menu selection and providing user commands to the CPU 450 (e.g., freezing or saving a still image). The microphone 486 can be used by the inspector to provide voice instructions to freeze or save a still image.

The video processor 460 can also communicate with video memory 462, which is used by the video processor 460 for frame buffering and temporary holding of data during processing. The CPU 450 can also communicate with CPU program memory 452 for storage of programs executed by the CPU 450. In addition, the CPU 450 can be in communication with volatile memory 454 (e.g., RAM), and non-volatile memory 456 (e.g., flash memory device, a hard drive, a DVD, or an EPROM memory device). The non-volatile memory 456 is the primary storage for streaming video and still images.

The CPU 450 can also be in communication with a computer I/O interface 458, which provides various interfaces to peripheral devices and networks, such as USB, Firewire, Ethernet, audio I/O, and wireless transceivers. This computer I/O interface 458 can be used to save, recall, transmit, and/or receive still images, streaming video, or audio. For example, a USB “thumb drive” or CompactFlash memory card can be plugged into computer I/O interface 458. In addition, the video inspection device 400 can be configured to send frames of image data or streaming video data to an external computer or server. The video inspection device 400 can incorporate a TCP/IP communication protocol suite and can be incorporated in a wide area network including a plurality of local and remote computers, each of the computers also incorporating a TCP/IP communication protocol suite. With incorporation of TCP/IP protocol suite, the video inspection device 400 incorporates several transport layer protocols including TCP and UDP and several different layer protocols including HTTP and FTP.

It will be understood that, while certain components have been shown as a single component (e.g., CPU 450) in FIG. 4, multiple separate components can be used to perform the functions of the CPU 450.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a touch-screen display, a cathode ray tube (CRT) or liquid crystal display (LCD) monitor, for receiving inputs and for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
acquiring, by an image sensor of an inspection system, inspection data characterizing a video of at least a portion of an asset being inspected, wherein the asset includes one or more components;
receiving, from the image sensor by one or more processors of the inspection system, the inspection data;
identifying, automatically by the one or more processors, at least a first component of the one or more components;
generating, by the one or more processors, a graphical user interface (GUI) comprising the inspection data;
generating, by the one or more processors, a first dynamic identifier within the GUI, wherein the first dynamic identifier corresponds to the first component and is configured to follow the first component as it moves within the GUI; and
providing the GUI to a user interface display of the inspection system.

2. The method of claim 1, wherein the first dynamic identifier is configured to displayed be over top of and move dynamically with the first component.

3. The method of claim 1, wherein the first dynamic identifier includes a visual indication of at least one of a first component type, a first component number, or a boundary of the first component.

4. The method of claim 1, further comprising:
determining, automatically by the one or more processors, an inspection status of the first component or a defect within the first component; and
modifying, by the one or more processors, a visual appearance of the first dynamic identifier to notify a user of the inspection status of the first component or a defect within the first component.

5. The method of claim 1, further comprising:
generating, by the one or more processors, within the GUI, a component information window comprising at least one of measurement data, analytic analysis results, an inspection status, geometric data, a flag for further review, an image quality metric, or inspection history data.

6. The method of claim 1, further comprising:
receiving, from a user via the GUI, an interaction with the first dynamic identifier; and
adjusting a position of the first dynamic identifier within the GUI based on the interaction.

7. The method of claim 6, wherein the interaction comprises a click and drag interaction by the user to move the first dynamic identifier from a first position within the GUI to a second position within the GUI.

8. The method of claim 1, wherein the inspection system is a borescope, and wherein the asset being inspected is a turbine and the one or more components comprise one or more turbine blades.

9. The method of claim 8, further comprising:
rotating the turbine using a turning tool while acquiring the inspection data such that the inspection data comprises a video of at least a portion of the plurality of turbine blades, wherein the identifying includes identifying at least a first turbine blade of the plurality of turbine blades, and wherein the first dynamic identifier corresponds to a first turbine blade of the plurality and is configured to follow the first turbine blade within the GUI as the turbine is rotated.

10. An inspection system comprising:
an image sensor configured to acquire inspection data characterizing a video of at least a portion of an asset being inspected, wherein the asset includes one or more components;
a computing system communicatively coupled to the image sensor and comprising a user interface display, one or more processors and a memory storing instructions which, when executed by the one or more processors cause the one or more processors to perform operations comprising:
receiving, from the image sensor, the inspection data,
identifying, automatically, at least a first component of the one or more components,
generating a graphical user interface (GUI) comprising the inspection data,
generating a first dynamic identifier within the GUI, wherein the first dynamic identifier corresponds to the first component and is configured to follow the first component as it moves within the GUI, and
providing the GUI to the user interface display.

11. The inspection system of claim 10, wherein the first dynamic identifier is configured to displayed be over top of and move dynamically with the first component.

12. The inspection system of claim 10, wherein the first dynamic identifier includes a visual indication of at least one of a first component type, a first component number, or a boundary of the first component.

13. The inspection system of claim 10, wherein the one or more processors are configured to perform operations further comprising:
determining, automatically, an inspection status of the first component or a defect within the first component; and
modifying a visual appearance of the first dynamic identifier to notify a user of the inspection status of the first component or a defect within the first component.

14. The inspection system of claim 10, wherein the one or more processors are configured to perform operations further comprising:
generating, within the GUI, a component information window comprising at least one of measurement data, analytic analysis results, an inspection status, geometric data, a flag for further review, an image quality metric, or inspection history data.

15. The inspection system of claim 10, wherein the one or more processors are configured to perform operations further comprising:
receiving, from a user via the GUI, an interaction with the first dynamic identifier; and
adjusting a position of the first dynamic identifier within the GUI based on the interaction.

16. The inspection system of claim 15, wherein the interaction comprises a click and drag interaction by the user to move the first dynamic identifier from a first position within the GUI to a second position within the GUI.

17. A borescope system comprising:
an image sensor configured to acquire inspection data characterizing a video of at least a portion of a turbine being inspected, wherein the turbine comprises a plurality of turbine blades;
a computing system communicatively coupled to the image sensor and comprising a user interface display, one or more processors and a memory storing instructions which, when executed by the one or more processors cause the one or more processors to perform operations comprising:
receiving, from the image sensor, the inspection data,
identifying, automatically, at least a first turbine blade of the plurality of turbine blades,
generating a graphical user interface (GUI) comprising the inspection data, generating a first dynamic identifier within the GUI, wherein the first dynamic identifier corresponds to the first turbine blade of the plurality and is configured to follow the first turbine blade as it moves within the GUI, and
providing the GUI to the user interface display.

18. The borescope system of claim 17, further comprising:
a turning tool configured to rotate the turbine while the image sensor is acquiring the inspection data.

19. The borescope system of claim 18, wherein the GUI further comprises a turning tool interface configured to allow for a user to control the rotation of the turbine, and wherein the one or more processors are configured to perform operations further comprising:
receiving, from the user via the GUI, an interaction with the turning tool interface, and
controlling the turning tool to rotate the turbine based on the interaction.

20. The borescope system of claim 17, wherein the first dynamic identifier includes a visual indication of at least one of a first turbine blade number, or a boundary around the first turbine.
